(19) United States
(12) Patent Application Publication
(10) Pub. No.: US 2004/0013428 A1
(43) Pub. Date: Jan. 22, 2004

(54) Optical transmission apparatus with function of detecting status

(75) Inventors: Isao Nakajima, Kawasaki (JP); Kazunori Hayami, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/365,442

(22) Filed: Feb. 13, 2003

(30) Foreign Application Priority Data
Jul. 16, 2002 (JP) 2002-206908

(51) Int. Cl. H04J 14/00

(52) U.S. Cl. 398/43; 398/182

(57) ABSTRACT

A light source generates a continuous wave light. A data signal source generates a data signal. A pilot signal is multiplexed on the data signal. The frequency of the pilot signal is much lower than that of the data signal. An LN modulator modulates the continuous wave light using the data signal on which the pilot signal is multiplexed. A data detection unit monitors whether a frequency component two times as high as the frequency of the pilot signal is contained in the output light from the LN modulator. Unless the frequency component two times as high as the frequency of the pilot signal is contained, it is determined that the data signal has stopped or disappeared, and outputs an alarm.

### BACKGROUND OF THE INVENTION

1. Field of the Invention

The present invention relates to an optical transmission apparatus having the function of detecting the status of a data signal, and a method for detecting the operation status of the optical transmission apparatus.

2. Description of the Related Art

A well-known method for converting a signal to be transmitted in an optical communications system into an optical signal is a direct modulation of controlling a current for driving a light-emitting device such as a laser diode, etc. Since the direct modulation can be realized with a simple configuration, it has conventionally been used widely. However, in the direct modulation, it is difficult to transmit a high speed signal of Gigabit order (especially, over 10 GHz signal). Therefore, an external modulation method capable of transmitting a Gigabit signal has been developed.

FIG. 1 shows the configuration of the conventional optical transmission apparatus with an external modulation method. In this example, it is assumed that a Mach-Zehnder optical modulator is used as an external modulator.

A multiplexing unit (MUX) 100 multiplexes a plurality of input signals, and transmits the multiplexed data signals to an electro-optic conversion unit (E/O) 110. The electro-optic conversion unit 110 is provided with a light source (LD) 111, a waveform-reshaping device 112, a driver amplifier 113, and an LN modulator 114, and generates and transmits an optical signal corresponding to a given data signal.

The light source 111 is a laser diode, and generates a continuous wave (CW) light. The waveform-reshaping device 112 reshapes a waveform of an input data signal. The waveform-reshaping device 112 can converts an input data signal into, for example, an NRZ (no-return to zero) signal or an RZ (return to zero) signal. The driver amplifier 113 amplifies the output signal of the waveform-reshaping device 112, and outputs it to the LN modulator 114. The LN modulator 114 is a Mach-Zehnder optical modulator using a lithium niobate (LiNbO3), and modulates the continuous wave light according to the data signal provided by the driver amplifier 113. Therefore, an optical signal transmitted from the electro-optic conversion unit 110 is used for transmission of a data signal.

The optical transmission apparatus used in the optical communications system normally has the function of detecting the occurrence of an abnormal state. The apparatus shown in FIG. 1 has the function of detecting the stop of an optical output and the function of detecting the stop or disappearance of a data signal.

The stop of an optical output is detected by an photoreceptor (such as photo diode PD) 115 monitoring the output power of the LN modulator 114. In this case, a detection unit 116 raises an alarm when, for example, the output power of the LN modulator 114 becomes smaller than a predetermined value.

On the other hand, the stop or disappearance of a data signal is detected at the multiplexing unit 100. That is to say, when no signals are input into the multiplexing unit 100, or when no data signals are output from the multiplexing unit 100, the disconnection state of a data signal is detected.

Thus, the optical transmission apparatus for use in the optical communications system has the function of detecting the status of a transmitting operation.

However, the above mentioned detecting method has the following problem.

(1) If a data signal stops or disappears in the electro-optic conversion unit 110, it cannot be detected. Furthermore, the cause of an abnormal operation cannot be specified.

(2) A high speed data signal from the multiplexing unit 100 can be logically monitored, but an expensive device is required to monitor a Gigabit signal.

### SUMMARY OF THE INVENTION

The present invention aims at detecting the stop or disappearance of a data signal in the optical transmission apparatus, and specifying the cause of an abnormal operation in the optical transmission apparatus.

The optical transmission apparatus according to the present invention transmits an optical signal using an optical modulator in which optical power of output light is periodically changed in response to an input voltage, and includes: a generator for generating a low frequency signal with a frequency lower than that of a data signal for driving the optical modulator; a multiplexer for multiplexing the low frequency signal on the data signal, and providing the optical modulator with the data signal on which the low frequency signal is multiplexed; a detector for detecting a frequency component two times as high as a frequency of the low frequency signal from the output light of the optical modulator; and a determination unit for determining the status of the data signal based on the detection result of the detector.

With this configuration, the status of the data signal is determined according to the low frequency signal which is multiplexed on the data signal. That is to say, the status of the data signal is determined based on the output of the optical modulator. Therefore, it can be detected whether or not the data signal is actually input into the optical modulator.

The optical transmission apparatus can also include a duty adjustment unit for changing the duty cycle of the data signal. With this configuration, even if the data signal is an NRZ signal, the probability of existence of the H level of the data signal can be different from the probability of existence of the L level of the signal. Then, if the optical modulator is driven using this data signal, the output light of the optical modulator contains the frequency component two times as high as the frequency of the low frequency signal.

Additionally, the optical transmission apparatus can further include an operating point control unit for controlling the operating point of the optical modulator, and an operation switch unit for supplying a predetermined value as an operating point of the optical modulator when an abnormal condition is detected in the data signal by said determination unit. With this configuration, when a data signal stops or disappears, the optical modulator is initialized, thereby avoiding the unstable status of the operation of the optical modulator.

The optical transmission apparatus according to another aspect of the present invention includes: an electro-optic conversion unit for outputting an optical signal in response to an input data signal; an input monitor unit for monitoring the normality of the data signal to be input into the electro-optic conversion unit; and a monitor unit for monitoring the state of the operation of outputting the optical signal. The electro-optic conversion unit includes: an optical modulator in which the optical power of output light is periodically changed in response to the input voltage; a generator for generating a low frequency signal with a frequency lower than that of a data signal for driving the optical modulator; a multiplexer for multiplexing the low frequency signal on the data signal, and providing the optical modulator with the data signal on which the low frequency signal is multiplexed; a detector for detecting a frequency component two times as high as a frequency of the low frequency signal from the output light of the optical modulator; a determination unit for determining the status of the data signal based on the detection result of the detector; and an output monitor unit for monitoring the output power of the optical modulator. The monitor unit monitors the state of the operation of outputting the optical signal based on the monitoring result by the input monitor unit, the determination result by the determination unit, and the monitoring result by the output monitor unit.

With this configuration, when an abnormal operation occurs in the optical transmission apparatus, the cause of the abnormal operation can be specified. Practically, it can be detected whether the data signal has stopped or disappeared before it is input into the electro-optic conversion unit, the data signal has stopped or disappeared within the electro-optic conversion unit, or the light source has become faulty, etc.

### BRIEF DESCRIPTION OF THE DRAWINGS

FIG. 1 shows the configuration of the conventional optical transmission apparatus;

FIG. 2 shows the configuration of the LN modulator;

FIG. 3 shows the characteristic of the LN modulator;

FIG. 4 shows the principle of the operation of the LN modulator;

FIG. 5 shows the principle of the operation of the optical transmission apparatus according to the present invention;

FIG. 6 shows the configuration of the optical transmission apparatus according to an embodiment;

FIG. 7 shows the process of multiplexing a pilot signal on a data signal;

FIG. 8A shows the NRZ signal;

FIG. 8B shows the RZ signal;

FIG. 9 shows the optical signal generated according to the data signal on which a pilot signal is multiplexed;

FIG. 10 shows the operation performed when the operating point voltage is shifted in the positive direction;

FIG. 11 shows the operation performed when the operating point voltage is shifted in the negative direction;

FIGS. 12A and 12B show the process of controlling the operating point;

FIG. 13 shows the operation of the LN modulator performed when the data signal is an RZ signal;

FIG. 14 shows the characteristic of a sine function;

FIG. 15 shows the optical signal output from the LN modulator;

FIGS. 16A and 16B are explanatory views of a signal provided for the LN modulator when a data signal stops or disappears;

FIG. 17 shows the output of the LN modulator when a data signal stops or disappears;

FIGS. 18A and 18B are explanatory views of the operation of the detection unit;

FIG. 19 shows the operation of the LN modulator performed when a data signal is an NRZ signal;

FIG. 20 shows the configuration of the optical transmission apparatus according to another embodiment of the present invention;

FIGS. 21A through 21C show the process of the duty adjustment unit;

FIG. 22 shows an embodiment of the duty adjustment unit;

FIG. 23 shows the configuration of the optical transmission apparatus according to another embodiment of the present invention; and

FIG. 24 is a flowchart of the operation of an alarm monitor unit;

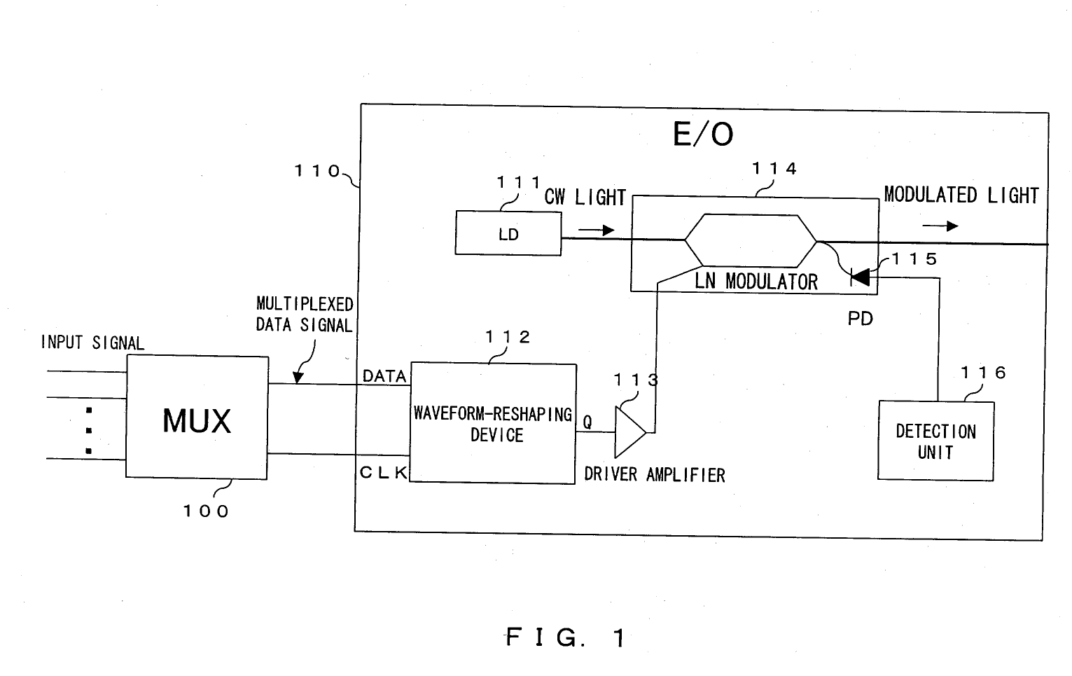

### DESCRIPTION OF THE PREFERRED EMBODIMENTS

The embodiments of the present invention are described below by referring to the attached drawings.

The optical transmission apparatus according to the embodiments of the present invention transmits an optical signal using an optical modulator in which the optical power of the output light periodically changes in response to an input voltage. In this embodiment, a Mach-Zehnder optical modulator is used as the optical modulator in which the optical power of the output light periodically changes in response to an input voltage. An example of a Mach-Zehnder optical modulator is an LN modulator. The LN modulator is an optical modulator having a waveguide formed using lithium niobate (LiNbO3).

The present invention relates to a method for detecting an abnormal condition of a data signal for driving the LN modulator. To make the method more easily understandable, the operation of the LN modulator is briefly described below.

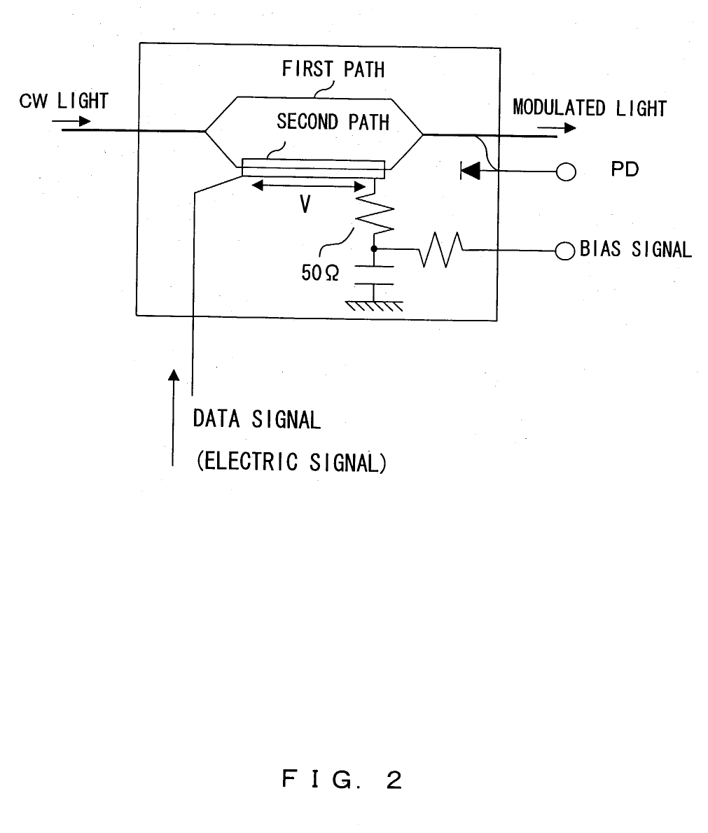

FIG. 2 shows the configuration of the LN modulator. The LN modulator normally receives a continuous wave light. The received continuous wave light is branched and guided to a first path and a second path. The second path is a waveguide formed using lithium niobate (LiNbO3), and the propagation speed of the light passing through the path is controlled by an applied voltage V. Therefore, by controlling the voltage V applied to the second path, the optical path difference between the above mentioned two paths is adjusted.

The lights passing through the above mentioned two paths are combined with each other. At this time, the optical power of the combined light changes by the phase difference between the light passing through the first path and the light passing through the second path. That is, for example, if the phases of a pair of the lights match each other, then the optical power of the combined light rises to a maximum value. If the pair of the lights are opposite in phase, then the optical power of the combined light drops to a minimum value.

A data signal is provided for the LN modulator. The data signal is an electrical signal, and controls the voltage V applied to the second path. The optical power of the light output from the LN modulator (that is, the optical power of the combined light) depends on the voltage V applied to the second path. Therefore, the optical power of the light output from the LN modulator is controlled by the data signal. That is, the input continuous wave light is modulated by the data signal.

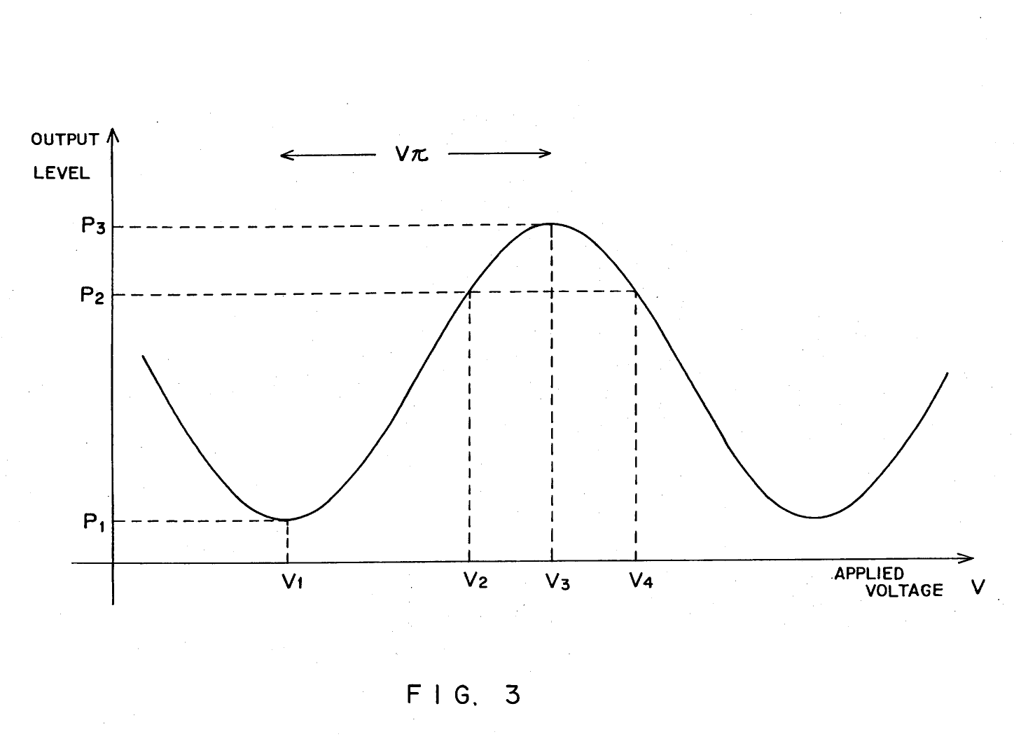

FIG. 3 shows the characteristic of the LN modulator. In FIG. 3, the applied voltage V indicates the voltage applied to the second path shown in FIG. 2. The output level indicates the optical power of the output light from the LN modulator when a continuous wave light is applied to the LN modulator.

The optical power of the output light from the LN modulator depends on the optical path difference between the first path and the second path as described above by referring to FIG. 2. Here, the optical path length of the first path is fixed. On the other hand, the optical path length of the second path changes with the applied voltage V. Therefore, the optical power of the output light from LN modulator periodically changes in response to the applied voltage V as shown in FIG. 3. Practically, it indicates the sine curve characteristic.

For example, when the applied voltage V=V1, the optical power of the output light indicates the minimum value P1. When the applied voltage V=V3, the optical power of the output light indicates the maximum value P3. In this case, the LN modulator is used such that the applied voltage V changes in the range from V1 to V3. Thus, the LN modulator can generate an output light with the optical power corresponding to the applied voltage V in the range from P1 to P3. Here, the voltage difference between the applied voltage for obtaining the maximum optical power and the applied voltage for obtaining the minimum optical power is often defined as “Vπ”.

Since the optical power of the output power from the LN modulator indicates the sine curve characteristic against the applied voltage V, the optical power indicates a certain value within the range from P1 to P3 even if the applied voltage V is out of the range from V1 to V3. For example, the optical power of the output light obtained when the applied voltage V=V4 is the same as the optical power of the output light obtained when the applied voltage V=V2. In this case, it is assumed that “V4−V3=V3−V2”.

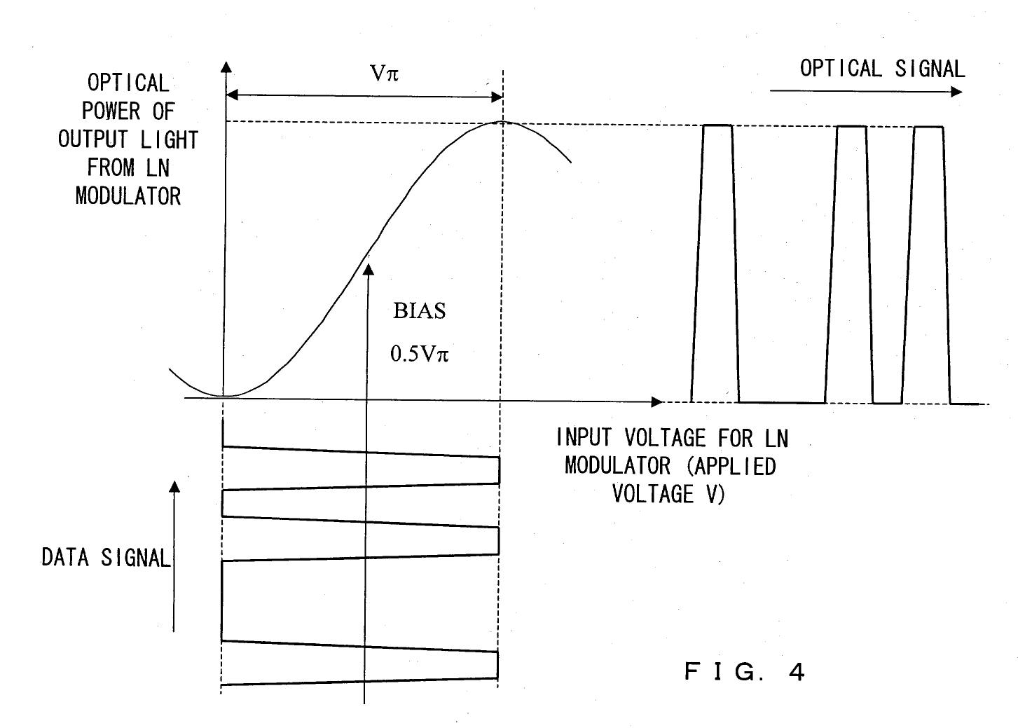

FIG. 4 shows the principle of the operation of the LN modulator. The LN modulator is controlled by the applied voltage V as described above. The applied voltage V depends on the data signal voltage based on the potential (operating point voltage) set by the bias signal shown in FIG. 2. Therefore, if the operating point voltage is constant, the optical power of the output light from the LN modulator is controlled by the data signal. That is, the data signal is used as a drive signal for driving the LN modulator. The example shown in FIG. 4 indicates the ideal operation status (operating point voltage=0.5 Vπ, and data signal amplitude=Vπ).

Thus, when the LN modulator is provided with the data signal having a predetermined amplitude, it generates an optical signal corresponding to the data pattern of the data signal.

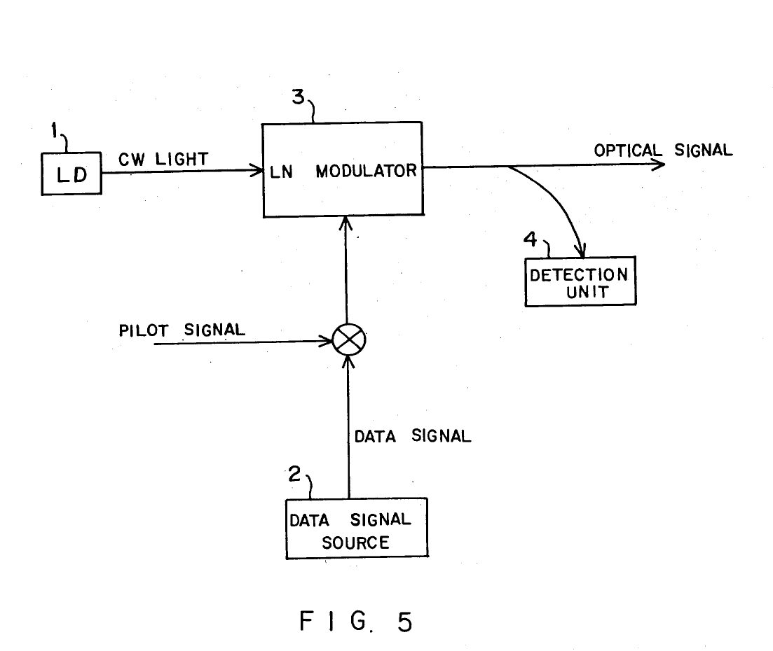

FIG. 5 shows the principle of the operation of the optical transmission apparatus according to the present invention. In FIG. 5, a light source (LD) 1 is, for example, a laser diode, and generates a continuous wave light. A data signal source 2 generates a data signal. An LN modulator 3 outputs an optical signal corresponding to the data signal by modulating the continuous wave light using the data signal as described above by referring to FIGS. 2 through 4.

A pilot signal is multiplexed on the above mentioned data signal. The pilot signal is a low frequency signal whose frequency is sufficiently lower than the data signal. A detection unit 4 monitors whether or not the output light of the LN modulator 3 contains the frequency component two times as much as the frequency component of the pilot signal. If that frequency component is contained, it is determined that the data signal has been provided for the LN modulator 3. On the other hand, if that frequency component has not been detected, then the detection unit 4 determines that no data signal has been provided for the LN modulator 3, thereby outputting an alarm.

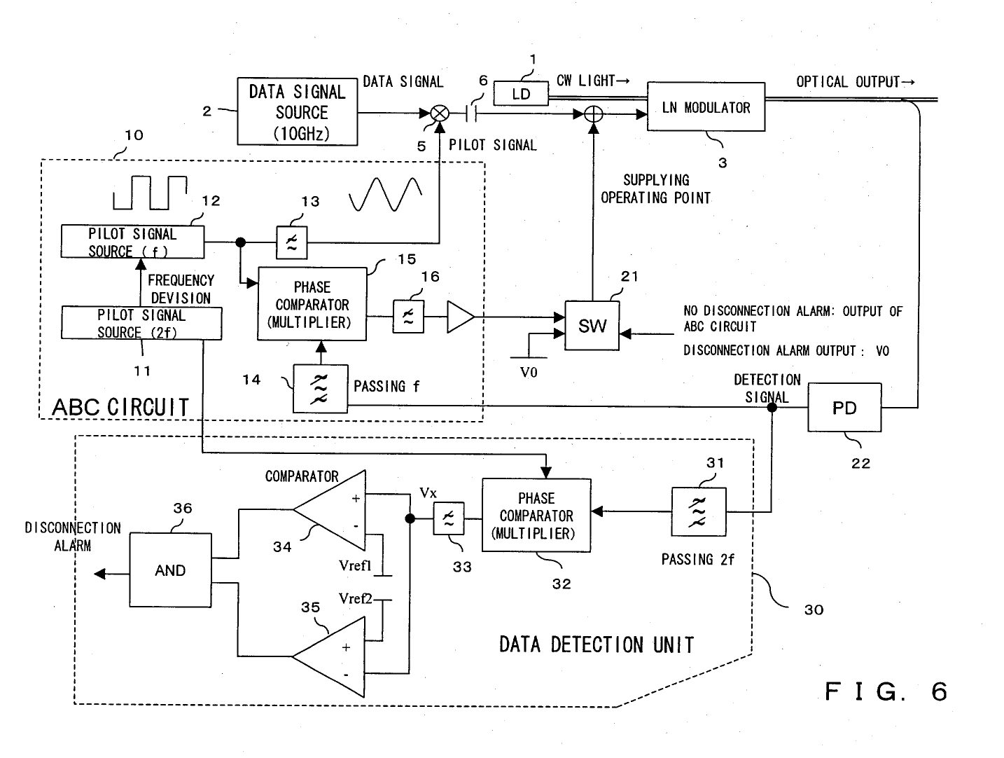

FIG. 6 shows the configuration of the optical transmission apparatus according to an embodiment of the present invention. The optical transmission apparatus transmits an optical signal corresponding to a data signal, and has the function of detecting a status described by referring to FIG. 5. In FIG. 6, the light source 1, the data signal source 2, and the LN modulator 3 are described by referring to FIG. 5. The detection unit 4 shown in FIG. 5 corresponds to a data detection unit 30 shown in FIG. 6.

An auto-bias control (ABC) circuit 10 has the function of generating a pilot signal and the function of adjusting the operating point voltage described above by referring to FIG. 4. The configuration and operation of the auto-bias control circuit 10 is described later in detail.

A switch 21 provides the bias voltage generated by the auto-bias control circuit 10 as an operating point voltage to the LN modulator 3 when the optical transmission apparatus performs a normal operation, and provides a predetermined voltage (for example, zero volt) as an operating point voltage for the LN modulator 3 when an abnormal operation occurs in the optical transmission apparatus.

A photoreceptor 22 is, for example, a photo diode, receives a part of the output light of the LN modulator 3, and converts the optical signal into an electric signal. Then, the output of the photoreceptor 22 is transmitted as a detection signal to the auto-bias control circuit 10 and the data detection unit 30.

The data detection unit 30 monitors the state of this optical transmission apparatus according to the signal provided from the photoreceptor 22. Practically, it monitors the presence/absence of a data signal, and outputs an alarm when the data signal stops or disappears. The configuration and the operation of the data detection unit 30 are described later in detail.

In the above mentioned optical transmission apparatus, the data signal generated by the data light source 2 is a drive signal for driving the LN modulator 3, and a high speed signal over 10 GHz. This data signal is, for example, an NRZ signal or an RZ signal.

On the other hand, a pilot signal is a low frequency signal having a frequency sufficiently lower than the data signal, and is generated as described below. That is, a pilot signal source 11 generates a rectangular wave signal with a predetermined frequency. A pilot signal source 12 frequency-divides the rectangular wave signal generated by the pilot signal source 11 by 2. Furthermore, a low pass filter 13 removes the high frequency component of the rectangular wave signal frequency-divided by the pilot signal source 12. The signal which has passed through the low pass filter 13 is output as a pilot signal. Therefore, the frequency of a rectangular wave signal generated by the pilot signal source 11 is two times as high as the frequency of the pilot signal. The frequency of the pilot signal is, for example, 1 kHz.

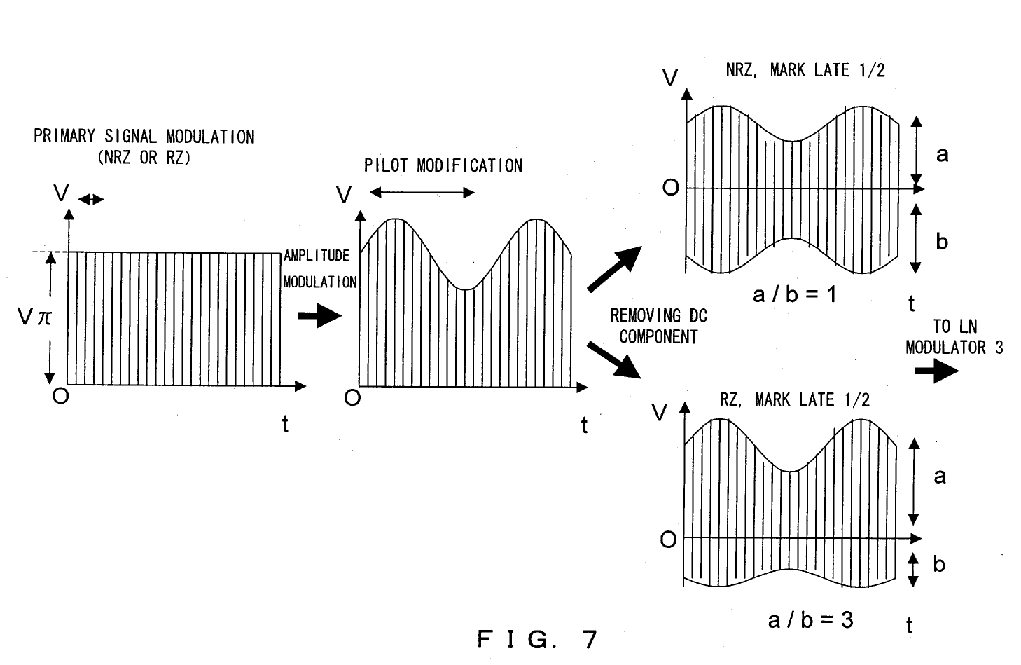

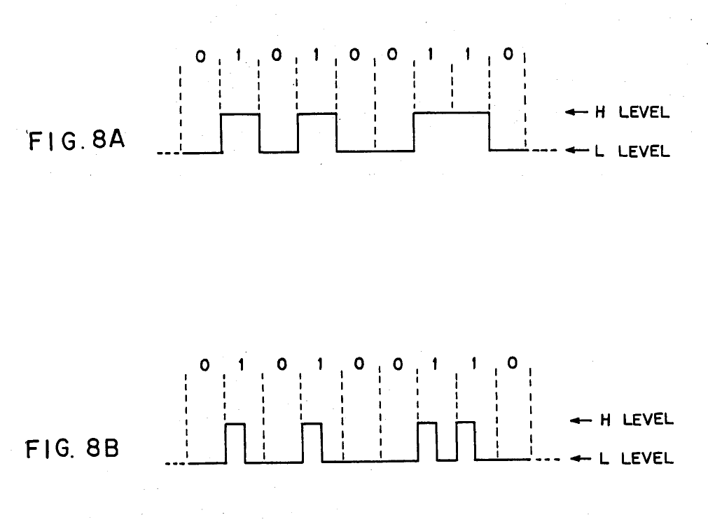

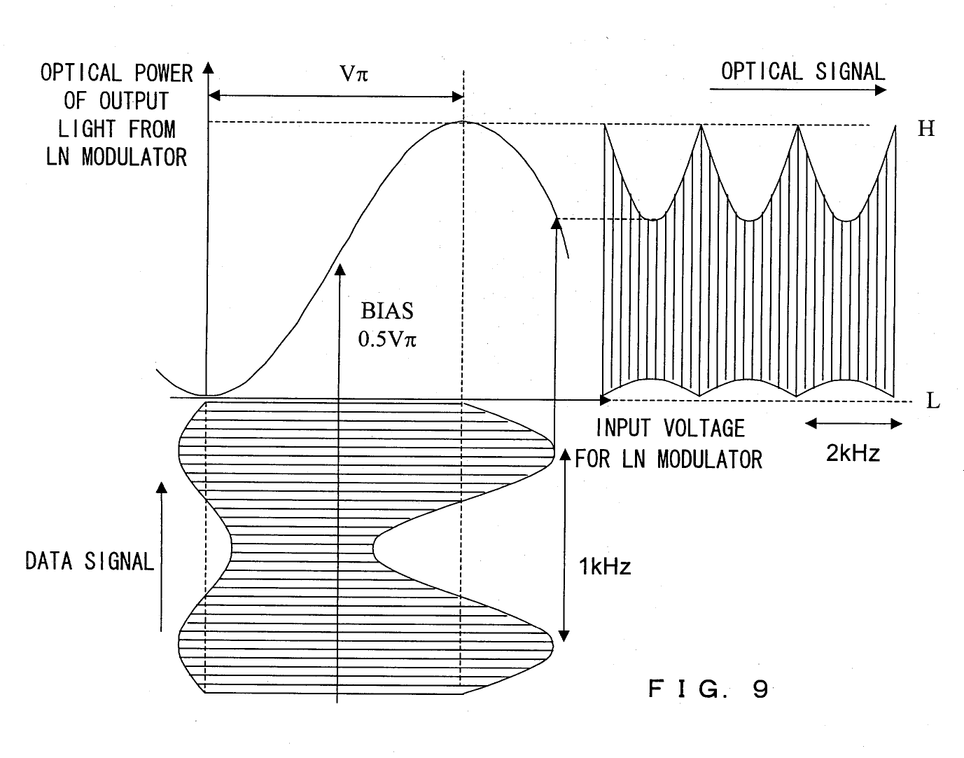

FIG. 7 shows the operation of multiplexing a pilot signal on a data signal. The data signal (primary signal) is an NRZ signal or an RZ signal, and its amplitude is “Vπ”. In the NRZ signal, “0 (zero)” is represented by “L level”, and “1” is represented by “H level”, as shown in FIG. 8A. Therefore, in this case, if the mark rate=½, that is, the number of bits indicating “0 (zero)” (or the probability of the existence of zero) in the data signal sequence and the number of bits indicating “1” (or the probability of the existence of 1) are substantially equal to each other, then the probability of the “H level” of the data signal and the probability of the “L level” of the data signal is ½, respectively.

On the other hand, in the RZ signal, “0 (zero)” is represented by “L level”, and “1” is represented by a combination of “H level” and “L level”, as shown in FIG. 8B. Therefore, in this case, assuming that the mark rate=½, the probability of the H level of the data signal is ¼, while the probability of the L level is ¾.

The pilot signal is a low frequency signal having a frequency sufficiently lower than the data signal, and its amplitude is smaller than Vπ. When a pilot signal is multiplexed on the data signal using a multiplier 5, that is, if the amplitude of a data signal is modulated using the pilot signal, a signal drawn at the center area of FIG. 7 can be obtained.

The data signal on which the pilot signal is multiplexed is provided for the LN modulator 3 after the DC component is removed using a capacitor 6 in the optical transmission apparatus according to an embodiment. At this time, if the data signal is an NRZ signal, the waveform on the positive side becomes equal to the waveform of on the negative side when the DC component is removed for the following reason. That is, after the DC component is removed, the data signal oscillates around the zero volt level, and an average amplitude component is zero if the zero volt level is set as a reference. Here, in the case of an NRZ signal, the probability of existence of each of the “H level” and the “L level” is “½” as described above. Therefore, the following equation is satisfied while the “amplitude for the H level (positive side amplitude)” is “a”, and the “amplitude for the L level (negative side amplitude)” is “b”.

a·(½)+b·(½)=0

That is, a:b=1:1

In the case of an RZ signal, when the DC component is removed, the waveform on the positive side is different from the waveform of the negative side for the following reason. That is, in the RZ signal, after the DC component is removed, an average amplitude component is also zero if the zero volt level is set as a reference. However, in the case of an RZ signal, the probability of existence of the “H level” is “¼”, while the probability of existence of the “L level” is “¾” as described above. Therefore, the following equation is satisfied while the “amplitude for the H level (positive side amplitude)” is “a”, and the “amplitude for the L level (negative side amplitude)” is “b”.

a·(¼)+b·(¾)=0

That is, a:b=3:1.

As described above, when the data signal is an NRZ signal, a data signal having symmetric waveforms on the positive and negative sides is provided for the LN modulator 3. On the other hand, when a data signal is an RZ signal, a data signal having asymmetric waveforms on the positive and negative sides is provided for the LN modulator 3.

Described below is the operation of the auto-bias control circuit 10. In this example, it is assumed that the data signal is an RZ signal. The auto-bias control circuit 10 performs the function of adjusting the operating point voltage described above by referring to FIG. 4.

As described above, the amplitude of a data signal is Vπ. Therefore, if a pilot signal is multiplexed, the amplitude of the data signal becomes larger or smaller than Vπ depending on the cycle of the pilot signal. The optical power of the output light from the LN modulator 3 when the amplitude of the data signal becomes larger than Vπ is smaller than the maximum value of the optical power of the output light from the LN modulator 3 as described above by referring to FIG. 3. Therefore, the power of the optical signal output from the LN modulator 3 periodically changes in synchronization with a pilot signal.

The optical signal output from the LN modulator 3 is converted into an electric signal by the photoreceptor 22, and transmitted to the auto-bias control circuit 10. After the electric signal passes through a band pass filter 14 for passing the same frequency component as the frequency of the pilot signal, it is transmitted to a phase comparator 15. The phase comparator 15 compares the pilot signal (a rectangular wave signal output by the pilot signal source 12) with the signal provided through the band pass filter 14. The phase comparator 15 is realized by, for example, a multiplier, and multiplies the above mentioned two signals. Furthermore, the output of the phase comparator 15 passes through a low pass filter 16, and then is provided for the LN modulator 3 as an operating point voltage. Then, the LN modulator 3 generates an optical signal according to the data signal using the provided operating point voltage as a reference.

Thus, the optical transmission apparatus according to an embodiment is provided with a feedback system for adjusting the operating point voltage.

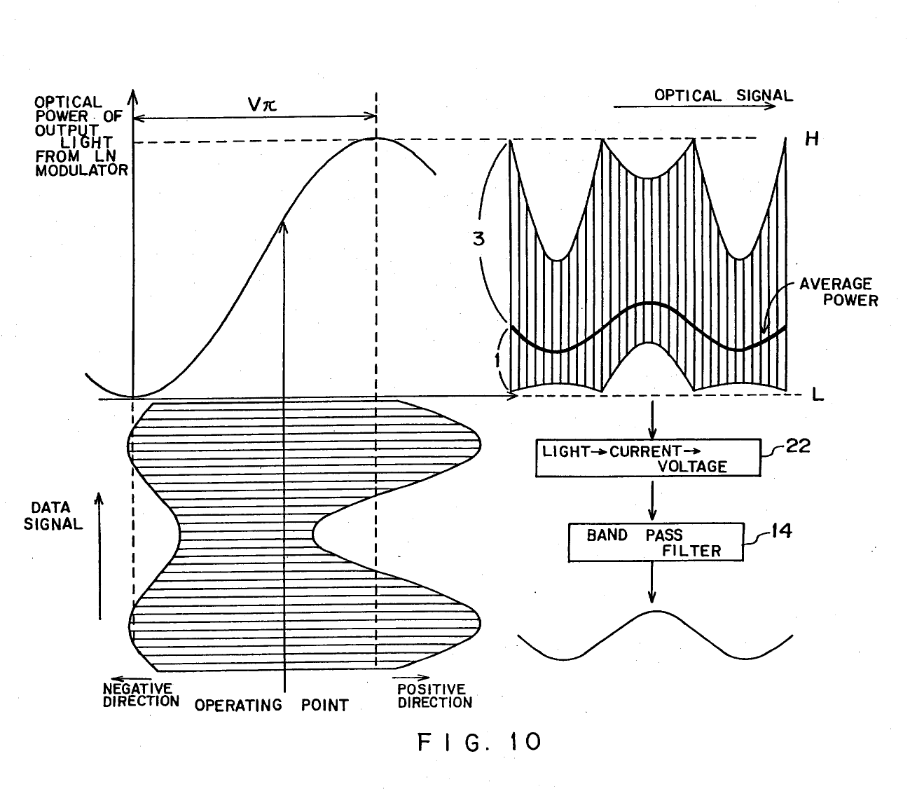

In the above mentioned feedback system, it is assumed, for example, that an operating point voltage has been shifted in the positive direction. In this case, the optical signal output from the LN modulator 3 changes as shown on the upper right area of FIG. 10. When the data signal is an RZ signal, the probability of the H level of the signal is ¼, while the probability of the L level of the signal is ¾. Thus, the average power of the optical signal output from the LN modulator 3 is obtained by computing the weighted average of 1:3 on the optical power at the H level and the optical power at the L level. Therefore, after converting the optical signal output from the LN modulator 3 into an electric signal, the resultant signal passes through the band pass filter 14, a sine wave having the same cycle as the pilot signal is to be obtained.

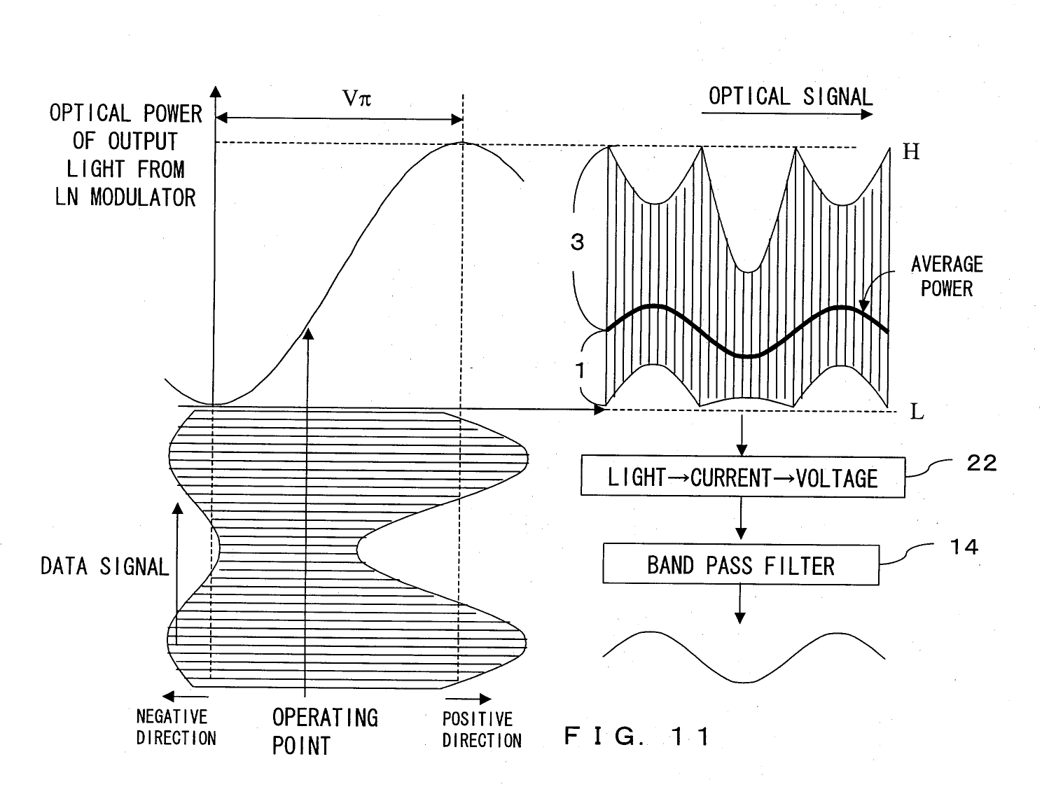

In the above mentioned feedback system, assume that, for example, an operating point voltage has been shifted in the negative direction as shown in FIG. 11. In this case, the optical signal output from the LN modulator 3 changes as shown on the upper right area of FIG. 11. Therefore, after the optical signal i.s converted into an electric signal, the resultant signal passes through the band pass filter 14, a sine wave having the same cycle as the pilot signal is to be obtained as in the case shown in FIG. 10. However, the phase of the signal output from the low pass filter is inverted between when the operating point voltage is shifted in the positive direction and when it is shifted in the negative direction.

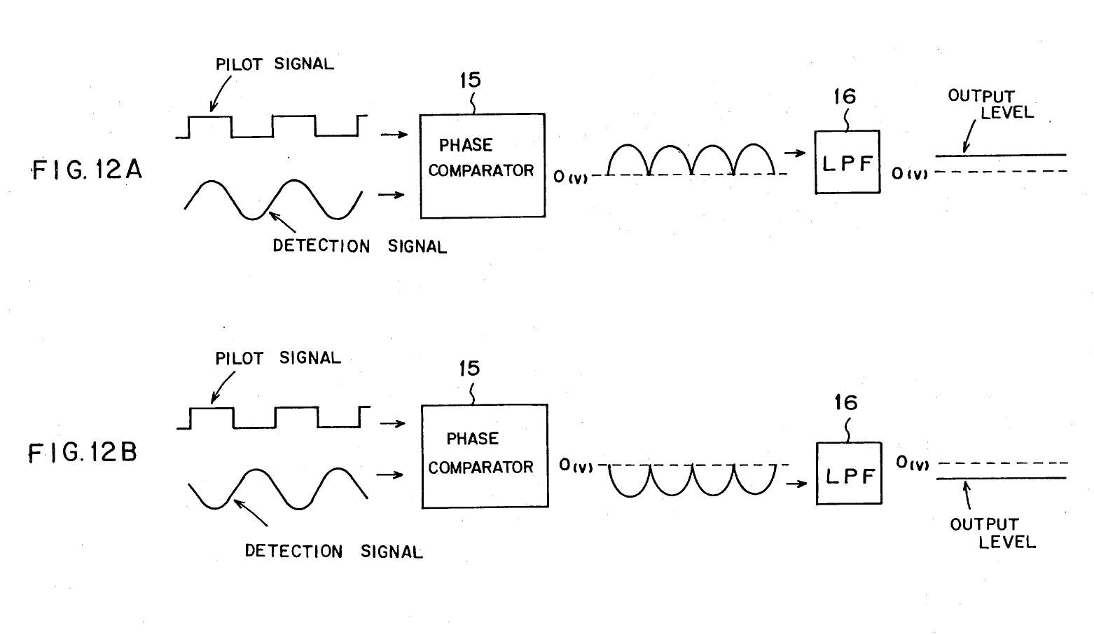

FIGS. 12A and 12B show the process of controlling the operating points. The phase comparator 15 multiplies the pilot signal (a rectangular wave signal output from the pilot signal source 12) by the detection signal provided through the band pass filter 14 as described above. Assuming that the pilot signal matches the detection signal in phase when the operating point voltage is shifted in the positive direction, a positive value corresponding to a shift amount can be obtained, as shown in FIG. 12A, when the DC component of the output of the phase comparator 15 is removed using the low pass filter 16. On the other hand, if the operating point voltage is shifted in the negative direction, then the phase of the detected voltage is inverted, and a negative value corresponding to the shift amount is obtained, as shown in FIG. 12B, when the DC component of the output of the phase comparator 15 is removed using the low pass filter 16.

The feedback system operates such that the output of the low pass filter 16 can be zero. Therefore, in the optical transmission apparatus according to the embodiment of the present invention, the operating point voltage automatically converges into the optimum value. Practically, the bias voltage is controlled to be 0.5 Vπ.

Described below is the configuration and operation of the data detection unit 30. The data detection unit 30 comprises a band pass filter 31, a phase comparator 32, a low pass filter 33, comparators 34 and 35, and a logical AND circuit 36. The band pass filter 31 and the phase comparator 32 performs basically the same operation as the band pass filter 14 and the phase comparator 15. However, the band pass filter 14 passes the same frequency component as the pilot signal, while the band pass filter 31 passes the frequency component two times as high as the frequency of the pilot signal. Furthermore, the phase comparator 15 multiplies the pilot signal by the detection signal, and the phase comparator 32 multiplies the rectangular wave signal having a frequency two times as high as the pilot signal by the detection signal. The output of the phase comparator 32 is averaged by the low pass filter 33.

The output of the low pass filter 33 is to be a predetermined value other than zero as described above by referring to FIGS. 12A and 12B, if the output light transmitted from the LN modulator 3 contains the frequency component two times as high as the frequency of the pilot signal. Therefore, if the, output of the low pass filter 33 is monitored using the comparators 34 and 35, then it can be detected whether or not the output light transmitted from the LN modulator 3 contains the frequency component two times as high as the frequency of the pilot signal.

Described below is the frequency component two times as high as the frequency of the pilot signal is contained in the output light transmitted from the LN modulator 3, when the optical transmission apparatus operates in a normal condition. “Operating in a normal condition” refers to a state where the data signal is provided for the LN modulator 3 without stop or disappearance.

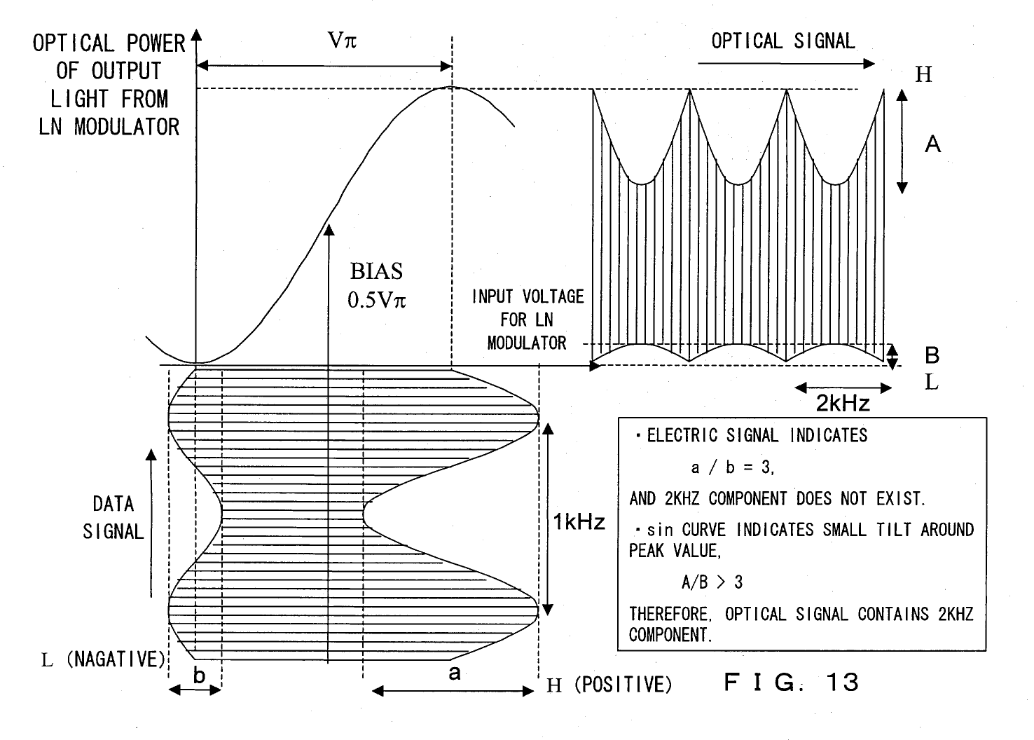

FIG. 13 shows the operation of the LN modulator 3 when the data signal is an RZ signal. When the data signal is an RZ signal, the ratio of the component of the positive side of the data signal on which a pilot signal is multiplexed to the component of the negative side of the data signal is 3:1 as described above by referring to FIGS. 6 and 7 with the frequency of the pilot signal taken into account. Therefore, in this case, the ratio of the amplitude “a” of the waveform on the positive side of the data signal on which the pilot signal is multiplexed to the amplitude “b” of the waveform on the negative side is also 3:1. At this time, if the amplitude of the data signal is Vπ, then the waveform on the positive side of the data signal periodically changes with the amplitude “a”, and the waveform is oscillated around the value corresponding to the maximum value of the sine curve indicating the optical power of the output light from the LN modulator 3. On the other hand, the waveform on the negative side of the data signal periodically changes with the amplitude “b”, and the waveform is oscillated around the value corresponding to the minimum value of the sine curve indicating the optical power of the output light from the LN modulator 3.

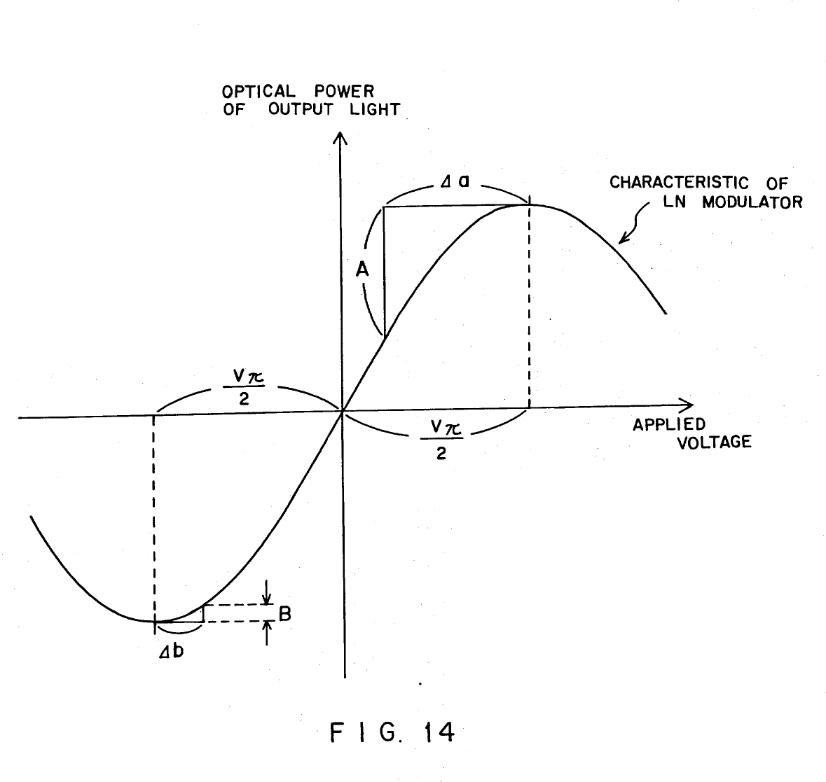

The sine curve shows a small change rate around the maximum value or the minimum value, and the change rate becomes larger when the value is farther from the maximum value or the minimum value as shown in FIG. 14. That is, if the applied voltage to the LN modulator 3 changes by “Δa” at the maximum value (or minimum value) of the sine curve, then the optical power of the output light from the LN modulator 3 changes by “ΔA”. On the other hand, if the applied voltage to the LN modulator 3 changes only by “Δb” at the minimum value (or maximum value) of the sine curve, the optical power of the output light from the LN modulator 3 changes by ΔB. In this case, the following relation is satisfied based on the characteristic of the sine function.

Δa/Δb≠ΔA/ΔB (where Δa≠Δb)

Practically, when the data signal is an RZ signal, “ΔA/ΔB>3” is obtained corresponding to “Δa/Δb=3”. Therefore, in the example shown in FIG. 13, “A/B>3” is obtained with the waveform of the optical signal output from the LN modulator 3.

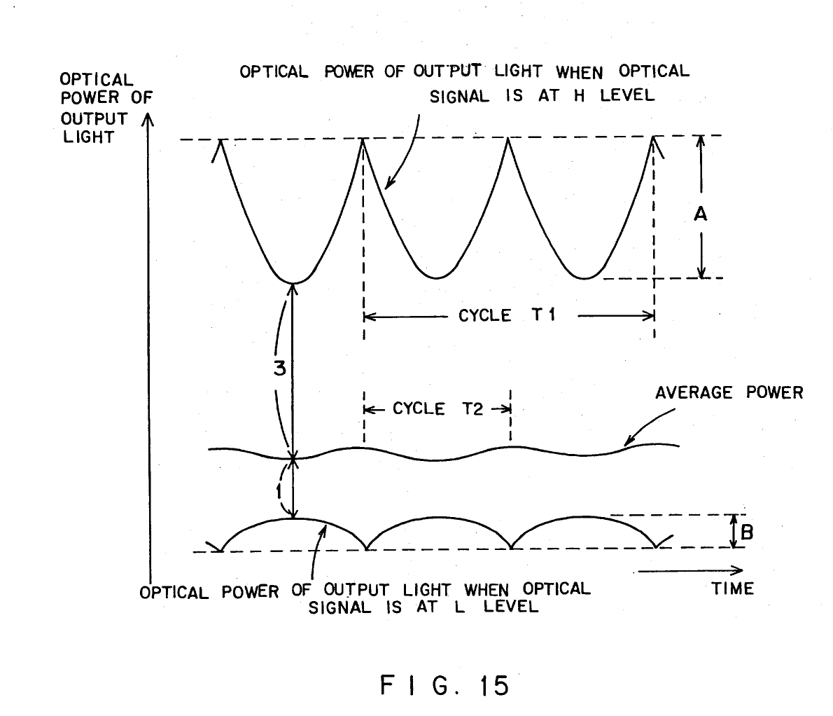

FIG. 15 shows an optical signal output from the LN modulator 3. The data signal is an RZ signal. When the data signal is an RZ signal, the probability of the “H level” of the signal is “¼”, while the probability of the “L level” of the signal is “¾”. Therefore, the average power of the optical signal is obtained by computing the weighted average of 1:3 on the optical power at the “H level” and the optical power at the “L level”. At this time, the waveform of the optical signal does not indicate 3:1 as the ratio of the amplitude A on the H level side to the amplitude B on the L level side. Therefore, the average power of the optical signal periodically changes. The cycle T2 of the average power is ½ of the cycle T1 of the pilot signal.

Thus, when the data signal is an RZ signal, and when the LN modulator 3 is driven according to the data signal on which the pilot signal is multiplexed, the average power of the optical signal output from the LN modulator 3 is changed by the frequency two times as high as the frequency of the pilot signal. That is, the optical signal output from the LN modulator 3 contains the frequency component two times as high as the frequency of the pilot signal.

However, when the data signal stops or disappears, the output light from the LN modulator 3 contains no frequency component two times as high as the frequency of the pilot signal. This process is described below.

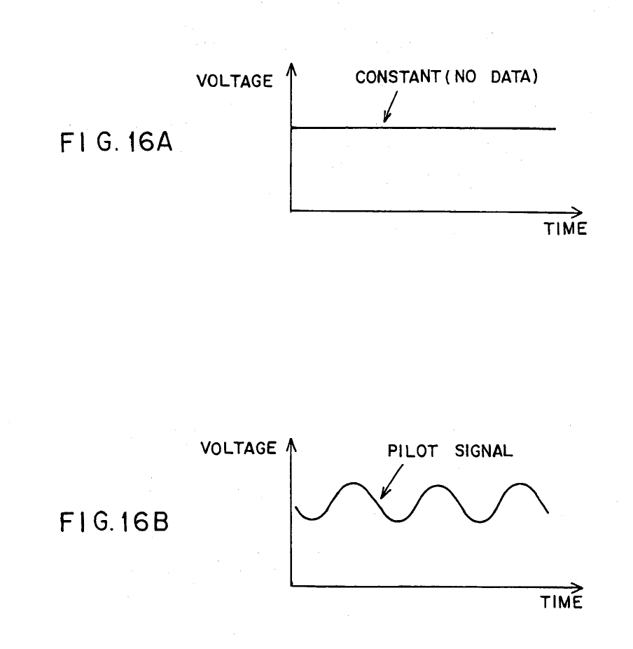

When the data signal stops or disappears, as shown in FIG. 16A, the voltage of the data signal is fixed to a constant value (including 0 volt). Therefore, when the fixed voltage signal is multiplied by a pilot signal, the pilot signal is outputted as a multiplication result as shown in FIG. 16B. Then, after the DC component of the signal is removed by the capacitor 6, the signal is provided for the LN modulator 3. The frequency of this signal is the same as the frequency of the pilot signal. That is, in this case, the LN modulator 3 is actually driven by the pilot signal.

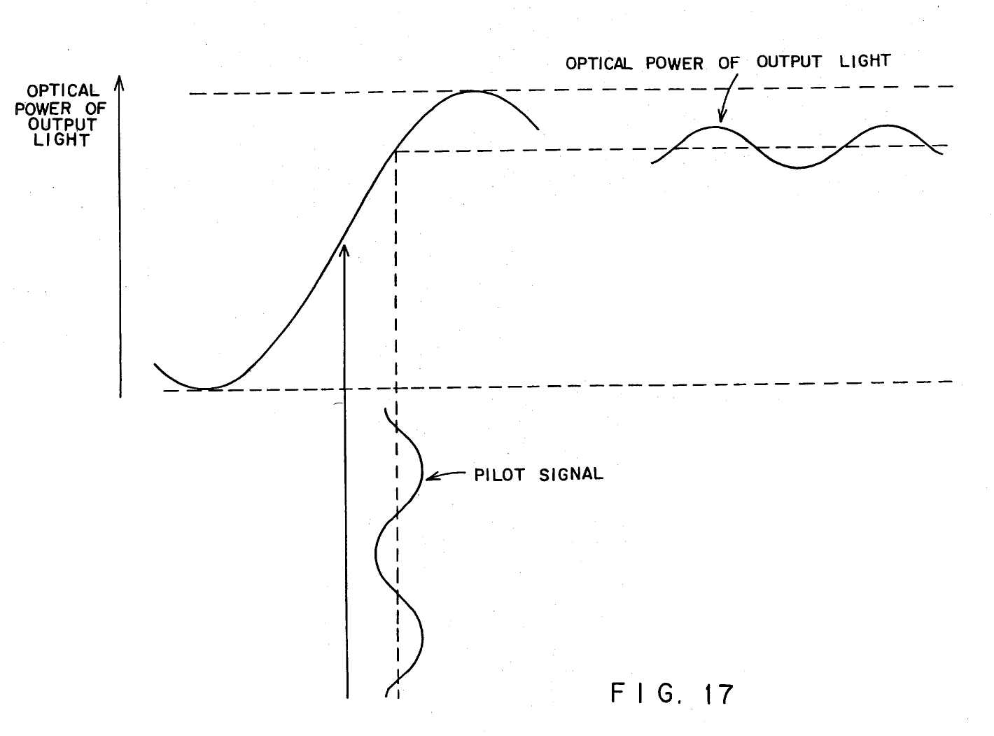

FIG. 17 shows the output light when the LN modulator 3 is driven by the pilot signal. In this case, the output light power from the LN modulator 3 changes at the same frequency as the pilot signal. That is, the output light from the LN modulator 3 does not contain the frequency component two times as high as the frequency of the pilot signal.

Thus, in the optical transmission apparatus according to an embodiment of the present invention, when the data signal stops or disappears, the output light from the LN modulator 3 does not contain the frequency component two times as high as the frequency of the pilot signal.

Therefore, if the output light from the LN modulator 3 is monitored and it is checked whether or not the output light contains the frequency component two times as high as the frequency of the pilot signal, then it can be determined whether or not a data signal has been correctly provided for the LN modulator 3. The determination is performed by the data detection unit 30 in the optical transmission apparatus according to the embodiment.

That is, first, the optical signal output from the LN modulator 3 is converted into an electric signal by the photoreceptor 22. The electrical signal obtained by the photoreceptor 22 is input into the band pass filter 31. Here, the passing frequency of the band pass filter 31 is the frequency two times as high as the frequency of the pilot signal. Therefore, if the optical signal output from the LN modulator 3 contains the signal having the frequency two times as high as the frequency of the pilot signal, then it is considered that the signal is provided for the phase comparator 32.

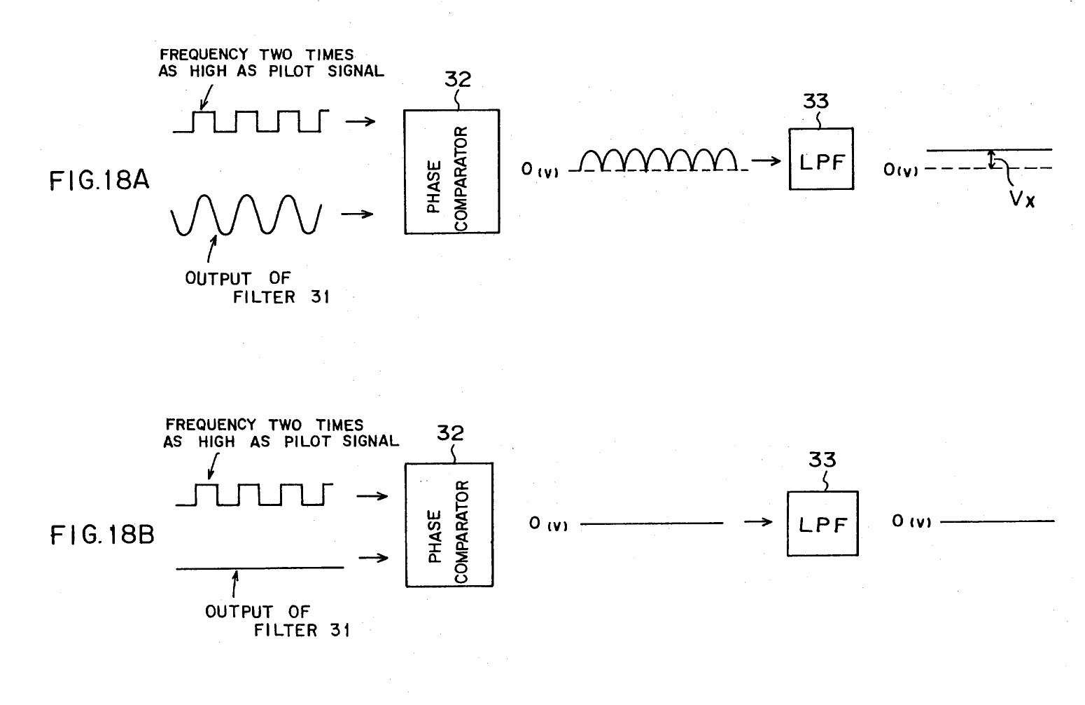

FIGS. 18A and 18B shows the operation of the phase comparator 32 and the low pass filter 33. If the output light from the LN modulator 3 contains a signal having the frequency two times as high as the frequency of the pilot signal, then a signal having the frequency two times as high as the frequency of the pilot signal is output from the band pass filter 31 as shown in FIG. 18A. Therefore, in this case, if the output of the phase comparator 32 is smoothed by the low pass filter 33, then the output voltage Vx from the low pass filter 33 is a certain value other than zero. On the other hand, if the output light from the LN modulator 3 does not contain a signal having the frequency two times as high as the frequency of the pilot signal, then the output of the band pass filter 33 is a null signal as shown in FIG. 18B. Therefore, in this case, the voltage Vx is zero.

The output of the low pass filter 33 is provided for the comparators 34 and 35. The comparator 34 outputs “H” when the voltage Vx is larger than the reference voltage Vref1, and outputs “L” when the voltage Vx is smaller than the reference voltage Vref1. The reference voltage Vref1 is a predetermined negative voltage near to zero. The comparator 35 outputs “H” when the voltage Vx is smaller than the reference voltage Vref2, and outputs “L” when the voltage Vx is larger than the reference voltage Vref2. The reference voltage Vref2 is a predetermined positive voltage near to zero.

Therefore, only when the voltage Vx is larger than the reference voltage Vref1 and smaller than the reference voltage Vref2, the outputs of the comparators 34 and 35 are “H”, and the output of the logical AND circuit 36 is also “H”. When the output of the logical AND circuit 36 is “H”, an alarm is output.

Thus, in the optical transmission apparatus according to an embodiment of the present invention, when a data signal is supplied to the LN modulator 3, the output light of the LN modulator 3 contains a signal having the frequency two times as high as the frequency of the pilot signal, and the output of the logical AND circuit 36 is “L”. On the other hand, when no data signal is supplied to the LN modulator 3, the output light of the LN modulator 3 does not contain the signal having the frequency two times as high as the frequency of the pilot signal, and the output of the logical AND circuit 36 is “H”. Thus, an alarm is output.

When the alarm is output, the switch 21 selects “zero”, and supplies it to the LN modulator 3. That is, the operating point of the LN modulator 3 is initialized. Therefore, although the data signal has stopped or disappeared, the operation of the LN modulator 3 can be prevented from being unstable. If “zero” is provided as an operating point voltage, the output level of the LN modulator 3 is set to the minimum value or a value close thereto. Therefore, if an alarm is output with the stop or disappearance of a data signal, then an output light of the optical transmission apparatus is stopped or controlled such that the output power can be smaller.

In the above mentioned embodiment, the operation of the optical transmission apparatus is described assuming that the data signal is an RZ signal. However, when the data signal is an NRZ signal, the stop or disappear of a data signal can not be detected with the same configuration.

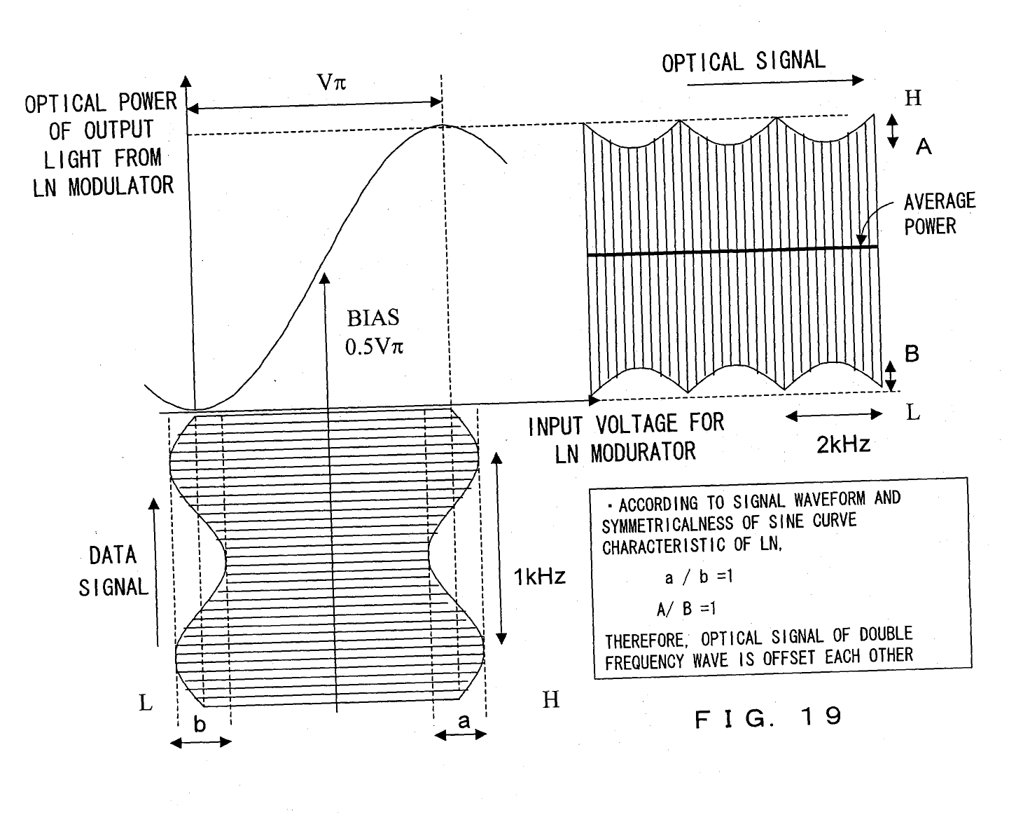

FIG. 19 shows the operation of the LN modulator when the data signal is an NRZ signal.

An NRZ data signal has the same waveforms on the H level side and the L level side as described above by referring to FIG. 7. In FIG. 19, the amplitude “a” on the H level side is the same as the amplitude “b” on the L level side. Therefore, when the LN modulator 3 is driven using the NRZ signal, the waveforms on the H level side and the L level side of an output optical signal are the same with each other. That is, in FIG. 19, the amplitude A on the H level side is the same as the amplitude B on the L level side.

Therefore, in this case, the average power of the optical signal output from the LN modulator 3 has a constant value. That is, the optical signal output from the LN modulator 3 does not contain the frequency component two times as high as the frequency of the pilot signal. Namely, with the configuration shown in FIG. 6, the stop or disappearance of a data signal cannot be detected by monitoring the output light of the LN modulator 3.

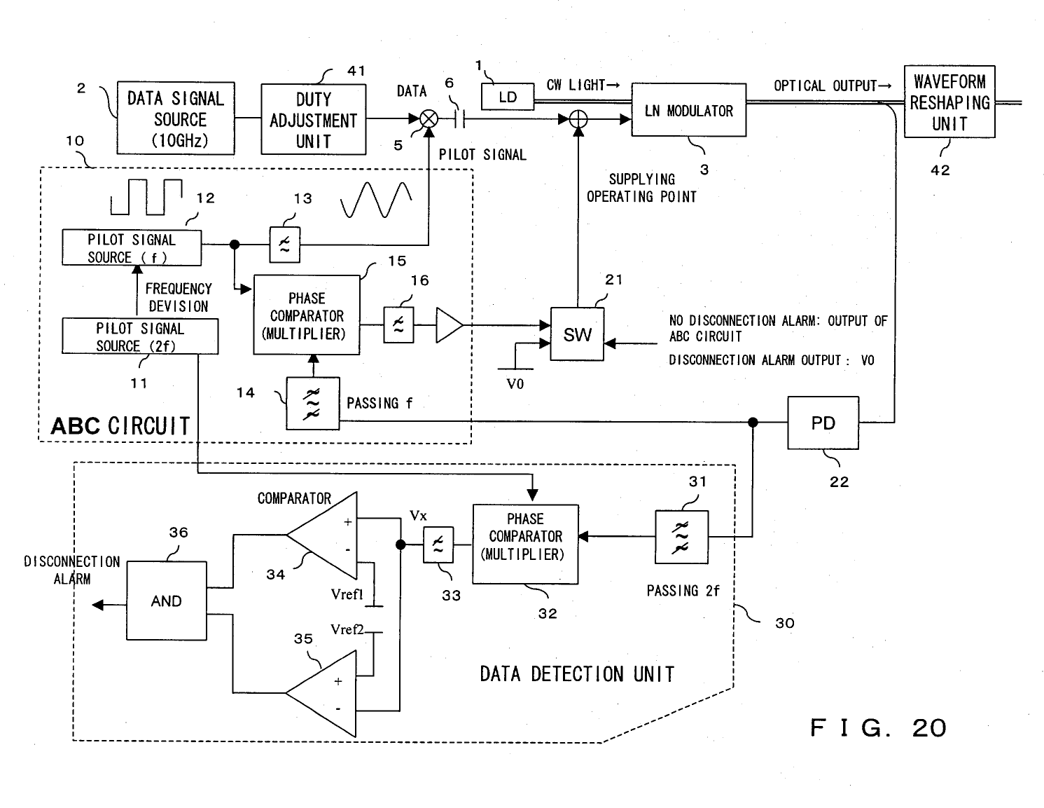

FIG. 20 shows the configuration of the optical transmission apparatus according to another embodiment of the present invention. The optical transmission apparatus is assumed to use an NRZ data signal.

The configuration of the optical transmission apparatus shown in FIG. 20 is basically the same as the optical transmission apparatus shown in FIG. 6. However, the data signal source 2 generates a NRZ signal. In addition, this optical transmission apparatus comprises a duty adjustment unit 41 for changing the duty of the NRZ data signal generated by the data signal source 2, and a waveform reshaping unit 42 for reshaping the waveform of an optical signal output from the LN modulator 3. The waveform reshaping unit 42 is provided to restore the duty cycle changed by the duty adjustment unit 41 to the original duty cycle, and can be realized by, for example, a dispersion compensation fiber.

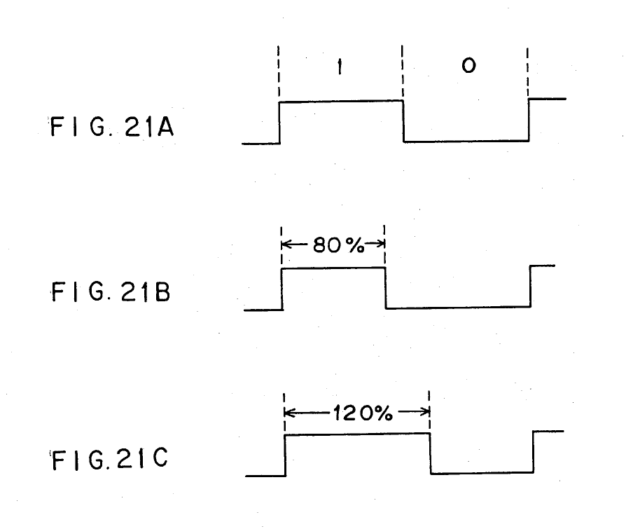

FIGS. 21A through 21C show the duty adjusting process performed by the duty adjustment unit 41. FIG. 21A shows the NRZ data signal generated by the data signal source 2. The data signal has the duty cycle of 100 percents. The duty adjustment unit 41 changes the duty cycle of the data signal shown in FIG. 21A. FIG. 21B shows the case in which the duty cycle of the data signal is lower than 100 percents, and FIG. 21C shows the case in which the duty cycle of the data signal is higher than 100 percents.

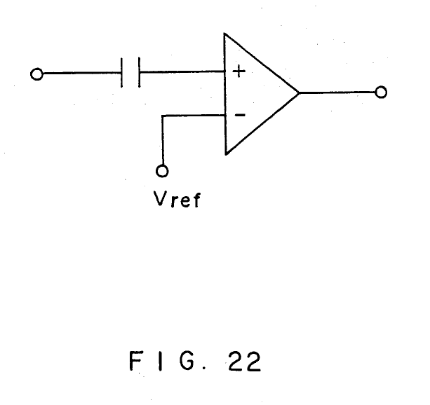

FIG. 22 shows an embodiment of the duty adjustment unit 41. The duty adjustment unit 41 according to the embodiment comprises the capacitor for removing the DC component of an input signal and the amplifier for amplifying the signal from which the DC component has been removed by the capacitor. A reference voltage Vref is applied to the inverted input terminal of the amplifier.

In the duty adjustment unit 41 with the above mentioned configuration, the duty cycle of the output signal remains the same as the duty cycle of the input signal, when the reference voltage Vref=0. However, when the reference voltage Vref>0, the duty cycle of the output signal is smaller than that of the input signal. That is, a signal with a duty cycle lower than 100 percents can be obtained. On the other hand, if the reference voltage Vref<0, then the duty cycle of the output signal is larger than that of the input signal. That is, a signal with a duty cycle higher than the input signal can be obtained.

If the duty cycle of the data signal is changed as described above, the ratio of the time of the signal at the “H level” to the ratio of the time of the signal at the “L level” is not 1:1. Therefore, when a pilot signal is multiplexed on the data signal whose duty cycle has been changed, the waveforms of the optical signal output from the LN modulator 3 is not symmetric between the H level side and the L level side as in the case of the RZ signal. As a result, as described above by referring to FIGS. 13 through 15, the output light contains the frequency component two times as high as the frequency of the pilot signal.

Thus, the optical transmission apparatus according to the present invention can detect the stop or disappearance of a data signal by monitoring the output light of the LN modulator 3 not only when the data signal is an RZ signal, but also when it is an NRZ signal.

Furthermore, the optical transmission apparatus according to the present invention can use not only RZ signal or NRZ signal but also other modulated signals in which the time period of the “H level” and the time period of the “L level” are not the same each other when the mark rate is ½, as the data signal for driving the LN modulator 3.

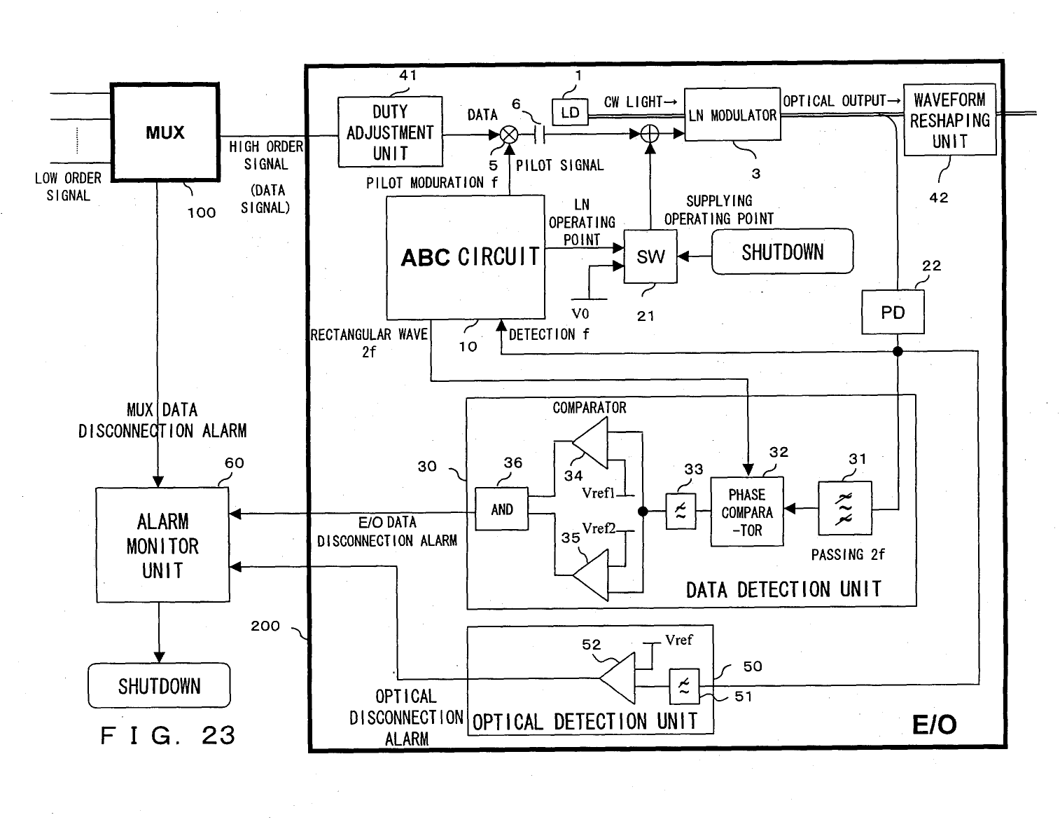

FIG. 23 shows the configuration of the optical transmission apparatus according to still another embodiment of the present invention. The configuration of the optical transmission apparatus shown in FIG. 23 is basically the same as the correction of the optical transmission apparatus shown in FIG. 20. However, the optical transmission apparatus has the function of specifying the cause of an abnormal operation when it occurs.

The multiplexing unit 100 multiplexes a plurality of input signals, and transmits to an electro-optic conversion unit (E/O) 200 the multiplexed data signal as a data signal for driving the LN modulator 3. The plurality of input signals are relatively low rate electric signals. This data signal corresponds to the data signal generated by the data signal source 2 shown in FIG. 6 or 20.

The multiplexing unit 100 has the function of detecting the presence/absence of an input signal, and the function of detecting whether a data signal has been output. The detection results obtained by the functions are transmitted to an alarm monitor unit 60 described later. That is, the multiplexing unit 100 outputs an “MUX data disconnection alarm” when an input signal or a data signal cannot be detected. The above mentioned detecting process is to, for example, monitor the presence/absence of a rising edge or a trailing edge of an electric signal, and is realized by the conventional technology.

The auto-bias control (ABC) circuit 10 controls the operating point voltage for the LN modulator 3 as described above, and generates a pilot signal to be multiplexed on a data signal. Additionally, the data detection unit 30 determines as described above whether the data signal has stopped or disappeared based on whether the frequency component two times as high as the frequency of the pilot signal is contained in the optical signal output from the LN modulator 3. If the frequency component two times as high as the frequency of the pilot signal cannot be detected, the data detection unit 30 assumes that the data signal has stopped or disappeared, and outputs an “E/O data disconnection alarm”.

An optical detection unit 50 monitors the power of an optical signal output from the LN modulator 3, and outputs an “optical disconnection alarm” when the optical power is smaller than a predetermined value. The optical detection unit 50 comprises a low pass filter 51 for averaging the amplitude of a detection signal output from the photoreceptor 22, and a comparator 52 for comparing the output of the low pass filter 51 with a predetermined threshold. The output of the low pass filter 51 indicates the DC component of an optical signal output from the LN modulator 3.

The alarm monitor unit 60 monitors the state of the optical transmission apparatus based on the above mentioned various alarms. When an abnormal operation occurs, a shutdown alarm is transmitted to the switch 21. In this case, when the switch 21 receives the shutdown alarm, it selects “zero” as an operating point voltage, and supplies it to the LN modulator 3. When “zero” is provided as an operating point voltage, the optical power of the output light from the LN modulator 3 is set to the minimum value or its approximation, thereby avoiding the occurrence of an unstable operation. The alarm monitor unit 60 can be realized by a microcomputer, etc. for executing a prepared program, and can also be realized by a hardware circuit.

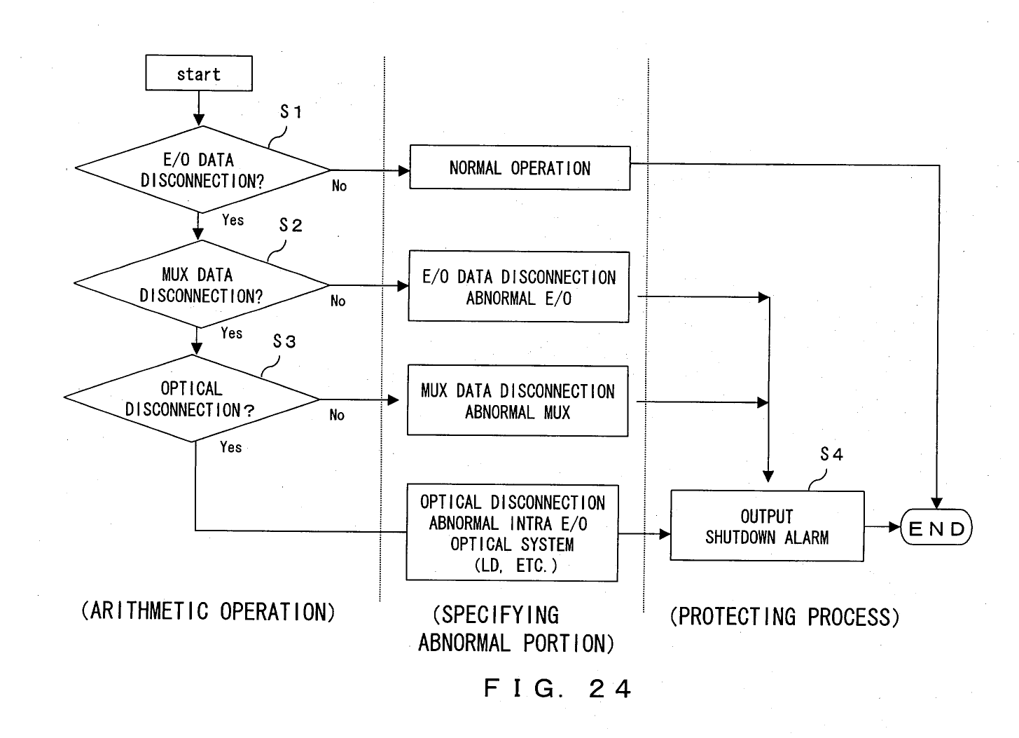

FIG. 24 is a flowchart of the operation of the alarm monitor unit 60. The operation is performed by, for example, a timer interruption at predetermined time intervals.

In step S1, it is determined whether or not the E/O data disconnection alarm has been received. Unless this alarm is received, it is assumed that the optical transmission apparatus operates in normal condition, thereby terminating the process. On the other hand, when an E/O data disconnection alarm has been received, control is passed to step S2.

In step S2, it is checked whether or not an MUX data disconnection alarm has been received. Unless this alarm has been received, since only the E/O data disconnection alarm has been received, it is determined that the data signal has disappeared in the electro-optic conversion unit 200. In this case, a shutdown alarm is output in step S4. On the other hand, if the MUX data disconnection alarm has been received, then control is passed to step S3.

In step S3, it is determined whether or not the optical disconnection alarm has been received. Unless this alarm has been received, it is determined that the data signal has not been input into the electro-optic conversion unit 200. That is to say, it is determined that the electro-optic conversion unit 200 can be faulty. In this case, the shutdown alarm is output in step S4. On the other hand, if the optical disconnection alarm has been received, then it is determined that the light source 1, the LN modulator 3, or a transmission line for transmitting an optical signal can be faulty. Also in this case, the shutdown alarm is also output in step S4.

The process order of each step in the flowchart shown in FIG. 24 is not limited to the above mentioned order. That is, for example, the process in step S3 can be performed before the process in step S2.

Furthermore, in the example shown in FIG. 24, the same shutdown alarm is generated regardless of the cause of an error, the information identifying the cause of an error can be included in the shutdown alarm. With this configuration, the cause of an abnormal operation can be easily recognized when it occurs.

In the above mentioned embodiment, the configuration includes an LN modulator as an optical modulator, but the present invention is not limited to this application. That is, the optical modulator is not limited to an LN modulator, but can be any modulator periodically changing the optical power of the output light depending on the applied voltage.

The amplitude of a data signal is ideally “Vπ”. However, the amplitude is not limited to the value, but it is desired that the maximum amplitude of a pilot signal on which a data signal is multiplexed is larger than “Vπ”.

According to the present invention, a low frequency signal is multiplexes on a data signal for driving an optical modulator, and the stop or the disappearance of the data signal is monitored using the low frequency signal. Therefore, an abnormal operation in the electro-optic conversion device can be detected. Furthermore, since a low frequency signal is used, the function of detecting a fault can be realized at a lower cost as compared with the configuration of directly monitoring a data signal.

What is claimed is:

1. An optical transmission apparatus which transmits an optical signal using an optical modulator in which optical power of output light is periodically changed in response to an input voltage, comprising:
a generator generating a low frequency signal with a frequency lower than that of a data signal for driving the optical modulator;
a multiplexer multiplexing the low frequency signal, on the data signal, and providing the optical modulator with the data signal on which the low frequency signal is multiplexed;
a detector detecting a frequency component two times as high as a frequency of the low frequency signal from the output light of the optical modulator; and
a determination unit determining a status of the data signal based on the detection result of said detector.

2. The apparatus according to claim 1, wherein
said optical modulator is a Mach-Zehnder optical modulator.

3. The apparatus according to claim 1, wherein
said optical modulator is an LN modulator.

4. The apparatus according to claim 1, wherein
the data signal is an RZ signal.

5. The apparatus according to claim 1, wherein
a probability of existence at a H level is different from a probability of existence at a L level in the data signal when a number of bits indicating zero is practically equal to a number of bits indicating one.

6. The apparatus according to claim 1, further comprising
a duty adjustment unit changing a duty cycle of the data signal.

7. The apparatus according to claim 6, further comprising
a waveform reshaping unit reshaping a waveform of an optical signal output from the optical modulator.

8. The apparatus according to claim 1, further comprising:
an operating point control unit controlling an operating point of the optical modulator; and
an operation switch unit supplying a predetermined value as an operating point of the optical modulator when an abnormal condition is detected in the data signal by said determination unit.

9. An optical transmission apparatus having an electro-optic conversion unit for outputting an optical signal in response to an input data signal, an input monitor unit for monitoring normality of the data signal to be input into the electro-optic conversion unit, and a monitor unit for monitoring a state of the operation of outputting the optical signal, wherein:
said electro-optic conversion unit comprises:
an optical modulator in which optical power of output light is periodically changed in response to an input voltage;
a generator generating a low frequency signal with a frequency lower than that of a data signal for driving said optical modulator;
a multiplexer multiplexing the low frequency signal on the data signal, and providing the optical modulator with the data signal on which the low frequency signal is multiplexed;
a detector detecting a frequency component two times as high as a frequency of the low frequency signal from output light of the optical modulator;
a determination unit determining a status of the data signal based on the detection result of the detection unit; and
an output monitor unit monitoring the output power of the optical modulator, wherein
said monitor unit monitors the state of the operation of outputting the optical signal based on the monitoring result by said input monitor unit, the determination result by said determination unit, and the monitoring result by said output monitor unit.

10. The apparatus according to claim 9, further comprising
a photoreceptor receiving a part of the output light from the optical modulator and generating an electric signal corresponding to the received light, wherein:
said detector detects a frequency component two times as high as a frequency of the low frequency signal using output of said photoreceptor unit; and
said output monitor unit monitors the optical power of the output light using the output of the photoreceptor unit.

11. The apparatus according to claim 9, further comprising:
an operating point control unit controlling an operating point of the optical modulator; and
an operation switch unit supplying a predetermined value as an operating point of the optical modulator when an abnormal condition is detected in the data signal by said determination unit.

12. A method, for use in an optical transmission apparatus which transmits an optical signal using an optical modulator in which optical power of output light is periodically changed in response to an input voltage, for detecting a stop or disappearance of a data signal for driving the optical modulator, comprising:
generating a low frequency signal with a frequency lower than that of the data signal;
multiplexing the low frequency signal on the data signal;
providing the optical modulator with the data signal on which the low frequency signal is multiplexed;
monitoring whether a frequency component two times as high as a frequency of the low frequency signal in output light of the optical modulator; and
determining a status of the data signal based on the monitoring result.

13. An optical transmission apparatus which transmits an optical signal using an optical modulator in which optical power of output light is periodically changed in response to an input voltage, comprising:
generating means for generating a low frequency signal with a frequency lower than that of a data signal for driving the optical modulator;
multiplexing means for multiplexing the low frequency signal on the data signal, and providing the optical modulator with the data signal on which the low frequency signal is multiplexed;
detecting means for detecting a frequency component two times as high as a frequency of the low frequency signal from the output light of the optical modulator; and
determining means for unit determining a status of the data signal based on the detection result of said detecting means.
